(19) United States
(12) Patent Application Publication
(10) Pub. No.: US 2015/0346049 A1
(43) Pub. Date: Dec. 3, 2015

(54) Quantitative Leak Detection System and Method

(71) Applicants: Brian E. Schwind, Waller, TX (US); Mark Stanley Parker, Waller, TX (US); Benny Eugene Parker, Waller, TX (US); B. Randy Sullivan, Waller, TX (US)

(72) Inventors: Brian E. Schwind, Waller, TX (US); Mark Stanley Parker, Waller, TX (US); Benny Eugene Parker, Waller, TX (US); B. Randy Sullivan, Waller, TX (US)

(73) Assignee: MECHANICAL TESTING SERVICES, LLC, Waller, TX (US)

(21) Appl. No.: 14/728,310

(22) Filed: Jun. 2, 2015

Related U.S. Application Data
(60) Provisional application No. 62/006,795, filed on Jun. 2, 2014.

(51) Int. Cl. G01M 3/00; G01M 3/28

(52) U.S. Cl. CPC G01M 3/007; G01M 3/2815

(57) ABSTRACT

A leak detection system includes a test equipment assembly connected to a leak detection assembly, which is connected to a data analyzer. The test equipment assembly includes a tubular section, and the test equipment assembly is configured to pressurize the tubular section during a pressure test. The leak detection assembly is configured to detect information related to the tubular section during the pressure test of the tubular section. The data analyzer is configured to process the information detected by the leak detection assembly, and the data analyzer is further configured to produce a leak rate of the tubular section.

### CROSS-REFERENCE TO RELATED APPLICATIONS

This application claims the benefit of U.S. Provisional Patent Application having Ser. No. 62/006,795, which was filed Jun. 2, 2014. This priority application is hereby incorporated by reference in its entirety into the present application to the extent consistent with the present application.

### BACKGROUND

Tests requiring leak detection capabilities are conducted on equipment used in many industries, including the automotive industry, heating, ventilation, and air conditioning (“HVAC”) industry, medical industry, environmental industry, and process industry. A common method to determine whether a leak is present in such equipment includes using a bubble method test. The bubble method test uses an inlet tubular that allows fluid, such as nitrogen, to be injected into the equipment. An exit conduit is connected to the equipment at one end, often at or near a boot, and is further connected to an inverted graduated cylinder at a second end.

The bubble method test includes injecting the gas into the inlet tubular at a substantially constant pressure, resulting in the injected gas flowing into the equipment. The equipment is pressurized and normalized to the substantially constant pressure, and the gas is allowed to exit the equipment by flowing through the exit conduit. Once the equipment is normalized, and a constant pressure is held within the equipment, a constant back pressure should be exerted on the exit conduit. However, if a leak is present within the equipment, the back pressure exerted on the exit conduit will drop causing a bubble to be visible within the inverted graduated cylinder.

Many problems are associated with the bubble method. For example, the bubble method may take an extended period of time to conduct. Hold times of less than fifteen minutes are generally not recognized as adequate leak detection tests, and the response time for a leak to appear within the inverted graduated cylinder may be significantly delayed, which may extend the length of time a bubble method test is conducted. In addition, a bubble may appear within the inverted cylinder indicating a leak when there is actually no leak present. For example, the equipment materials may expand and contract depending on back pressure, total gas volume, or temperature, which would affect the back pressure on the exit tubular and result in a bubble in the inverted cylinder. Further, the bubble method is not capable of distinguishing individual leak events, nor is it able to measure an actual leak rate. In addition, the bubble method may not be directly integrated into a data acquisition system and is typically only capable of testing a system that includes a maximum operating pressure of approximately 5 psi.

What is needed, then, is a system and method for detecting and quantifying leak rates within equipment that addresses the issues discussed above.

### SUMMARY

In one embodiment, a leak detection system may include a test equipment assembly connected to a leak detection assembly, which may be connected to a data analyzer. The test equipment assembly may include a tubular section, and the test equipment assembly may be configured to pressurize the tubular section during a pressure test. The leak detection assembly may be configured to detect information related to the tubular section during the pressure test of the tubular section. The data analyzer may be configured to process the information detected by the leak detection assembly, and the data analyzer may be further configured to produce a leak rate of the tubular section.

In one embodiment, a method of detecting leaks may comprise assembling a test equipment assembly, connecting a leak detection assembly to the test equipment assembly, and connecting the leak detection assembly to a data analyzer. The method of detecting leaks may further include pressurizing the test equipment assembly, detecting information related to the test equipment assembly during the pressurization, and displaying an analysis of the information on an external display.

In one embodiment, a leak detection system for test equipment may include a flow meter configured to detect information transmitted from a test equipment assembly via a conduit during a pressure test of the test equipment. The leak detection system may further include a data analyzer connected to the flow meter, wherein the data analyzer may be configured to use the information detected by the flow meter to determine a leak rate of the test equipment.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a block diagram of a system for detecting and analyzing leaks within a tubular section of a test equipment assembly, according to one or more embodiments disclosed.

FIG. 2 illustrates a schematic of the test equipment assembly that may be included in the system shown in FIG. 1, according to one or more embodiments disclosed.

FIG. 3 illustrates a schematic of the leak detection assembly that may be included in the system of FIG. 1, according to one or more embodiments disclosed.

FIG. 4 illustrates a block diagram of the leak detection assembly that may be included in the system of FIG. 1, according to one or more embodiments disclosed.

FIG. 5 is a flowchart of an illustrative method for identifying and quantifying a leak within the tubular section of the test equipment assembly, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

Example embodiments of the present disclosure include a leak detection system for detecting and analyzing leaks within process equipment, such as a tubular section or pipe. The process equipment to be tested is positioned within and included in a test equipment assembly, wherein a pressure test is conducted. During the pressure test, the test equipment assembly pressurizes the process equipment to a predetermined pressure for a certain period of time, and the test equipment assembly is monitored to determine whether a leak is present within the process equipment.

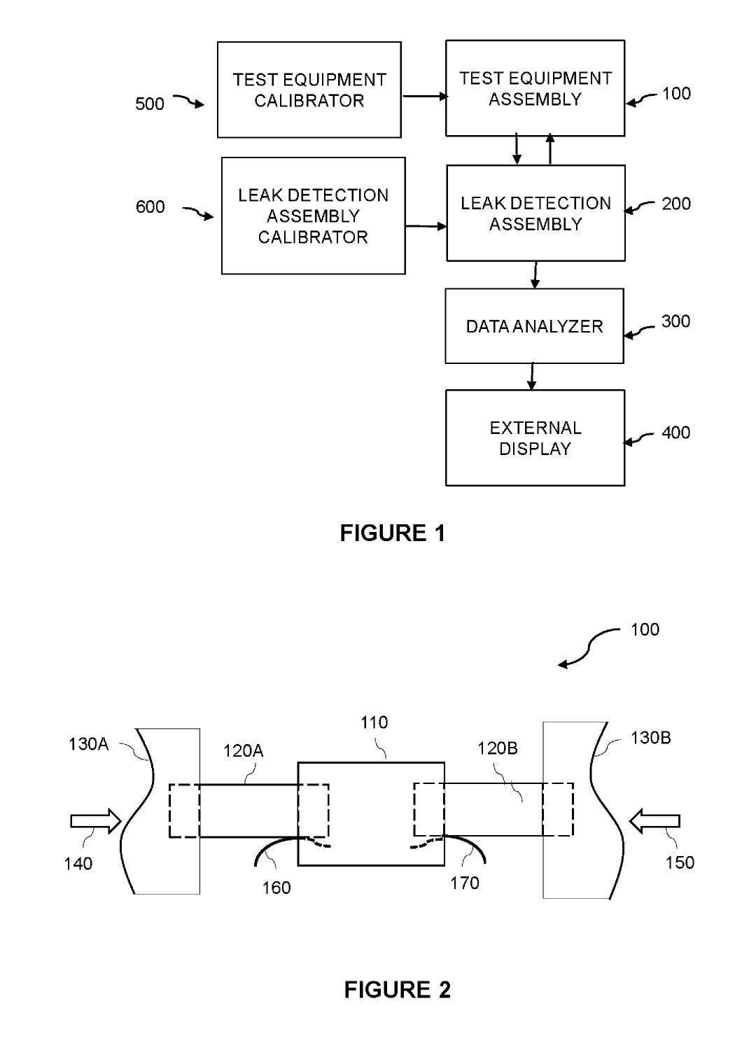

FIG. 1 illustrates a block diagram of a system 10 for detecting and analyzing leaks within a tubular section that is included within a test equipment assembly 100, according to one or more embodiments disclosed. As will be discussed further, the test equipment assembly 100 may include one or more tubular sections, such as joints of pipe, which are connected together by a component, such as a fitting. The test equipment assembly 100 may be connected to a leak detection assembly 200 that detects information related to pressure and fluid flow within the tubular sections when the tubular sections undergo a pressure test. The leak detection assembly 200 may be further connected to a data analyzer 300 that uses the information related to pressure and fluid flow within the test equipment assembly 100 to develop a pressure profile within the tubular sections and determine a leak rate within the tubular sections, if applicable. The data analyzer 300 may be connected to an external display 400, which displays the pressure profile and the leak rate of the tubular sections during the pressure test.

In at least one embodiment, the system 10 may include a test equipment calibrator 500 that ensures pressure may be held within the test equipment assembly 100 at a specified pressure. Similarly, in at least one embodiment, the system 10 may include a leak detection assembly calibrator 600 that ensures that the leak detection assembly 200 may accurately detect and record pressure, fluid flow rate, or other parameters. After the test equipment assembly 100 and the leak detection assembly 200 are calibrated, the test equipment assembly 100 may be connected to the leak detection assembly 200, and a pressure test may be conducted.

FIG. 2 illustrates a schematic of the test equipment assembly 100 that may be included in the system 10 shown in FIG. 1, according to one or more embodiments disclosed. The test equipment assembly 100 may include a first tubular section 120A and a second tubular section 120B, such as joints of pipe, which may be connected with a component 110. The component 110 may be a fitting, such as a boot. A first conduit 160 may be positioned at a first end 112 of the component 110, and a second conduit 170 may be positioned at a second end 114 of the component 110. The conduits 160, 170 may be further connected to the leak detection assembly 200, such that the conduits 160, 170 allow pressure and/or fluid flow rate within the component 110, and thus first and second tubular sections 120A, 1206, to be monitored by the leak detection assembly 200. The component 110 and conduits 160, 170 may be connected and sealed to the first and second tubular sections 120A, 120B such that pressure is substantially contained within the tubular sections 120A, 1206 and the component 110.

The first and second tubular sections 120A, 1206 may be further connected to a first and second test element 130A, 1306, respectively. For example, the first and second test elements 130A, 130B may also be joints of pipe that are connected via flanges to the tubular sections 120A, 1206, although other types of test elements and connection means are contemplated. The first and second test elements 130A, 1306 are connected to the first and second tubular sections 120A, 1206 such that pressure is contained within the test elements 130A, 1306 and the tubular sections 120A, 120B. One or both of the test elements 130A, 130B may allow fluid to be injected into the tubular sections 120A, 1206, such that the tubular sections 120A, 1206 are pressurized. For example, the test elements 130A, 1306 may inject a fluid, which may be an inert gas such as nitrogen, into the tubular sections 120A, 1206 at one or more test pressures. One or both of the test elements 130A, 1306 may also place other stimuli on one or more of the tubular sections 120A, 120B. For example, one or both of the test elements 130A, 130B may place one or both of the tubular sections 120A, 1206 under tension, under compression, under torsional stress, or may heat or cool the gas flowing through the tubular sections 120A, 120B.

Generally, the test equipment assembly 100 may be used to conduct a pressure test of the tubular sections 120A, 120B, such that the tubular sections 120A, 120B are verified to be able to withstand a predetermined pressure without significant leakage over a period of time. When pressure testing the tubular sections 120A, 1206, one or more of the test elements 130A, 1306 inject the inert gas into the tubular sections 120A, 120B, and the leak detection assembly 200 detects the pressure or fluid flow rate within the tubular sections 120A, 120B via the conduits 160, 170. While both of the conduits 160, 170 may be used to detect the pressure and/or fluid flow rate within the tubular sections 120A, 120B, it is contemplated that one conduit or more than two conduits may also be used to detect the pressure and/or fluid flow rate within the tubular sections 120A, 120B. The leak detection assembly 200 reads the pressure and/or fluid flow rate within the tubular sections 120A, 120B via the conduits 160, 170, and the pressure is analyzed by the data analyzer 300 and output to the external display 400. The leak detection assembly 200 and/or the data analyzer 300 record and detect when the tubular sections 120A, 1206 reach the predetermined pressure, and when the tubular sections 120A, 1206 are stabilized at such pressure. Once the pressure is applied within the tubular sections 120A, 120B, the pressure test may be conducted such that the predetermined pressure is held within the tubular sections 120A, 1206 for a certain period of time.

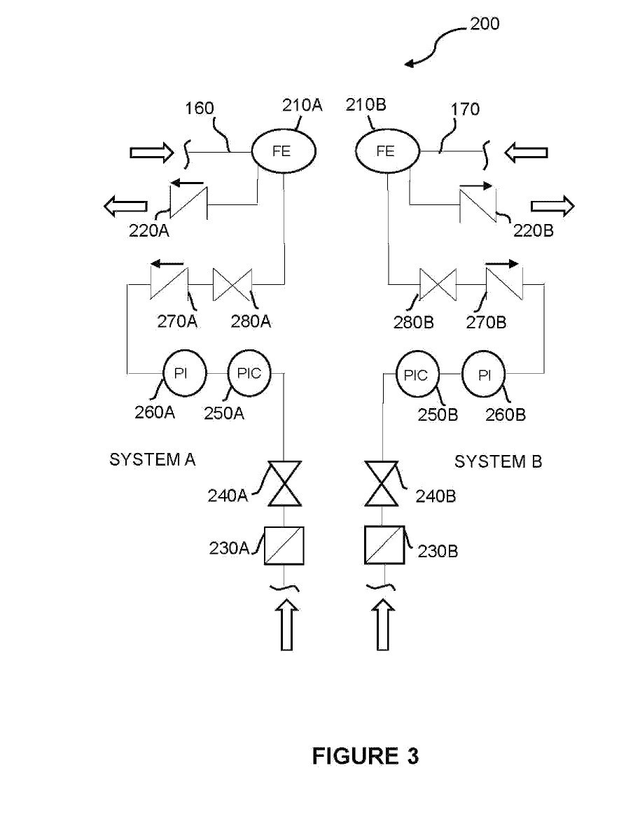

FIG. 3 illustrates a schematic of the leak detection assembly 200 that may be included in the system 10 of FIG. 1, according to one or more embodiments disclosed. The leak detection assembly 200 may include a first flow meter 210A and a first check valve 220A. The leak detection assembly 200 may also include a second flow meter 210B and a second check valve 220B. The conduits 160, 170 from the test equipment assembly 100 may be connected to the first and second flow meters 210A, 2106, respectively. In one embodiment, the flow meters 210A, 2106 may be Coriolis flow meters, but other types of flow meters are also contemplated. In one embodiment, the first and second flow meters 210A, 2106 may be further connected to the data analyzer 300, which records and analyzes information, such as fluid pressure, fluid temperature, or fluid flow rate, being detected by the flow meters 210A, 2106. The connection between the flow meters 210A, 2106 and the data analyzer 300 may be provided via a wired connection or wireless connection.

In one embodiment, the first and second check valves 220A, 2206 of the leak detection assembly 200 may allow fluid to flow out to the atmosphere, but prevent fluid from flowing into the line that leads to the flow meters 210A, 2106. In one embodiment, the check valves 220A, 2206 may be ball valves, but other types of uni-directional flow valves are also contemplated. During a pressure test of the test equipment assembly 100, fluid such as inert gas flows through the first and second tubular sections 120A, 1206 and through the component 110. A small amount of the fluid may also flow through the conduits 160, 170 on either side of the component 110, which then flows through the flow meters 210A, 2106 of the leak detection assembly 200 and then through the check valves 220A, 2206 out to the atmosphere.

In one embodiment, the data analyzer 300, such as a computer, receives and analyzes the information provided by the flow meters 210A, 2106, and includes firmware configured to generate a pressure analysis of the tubular sections 120A, 1206 during the pressure test. As the data analyzer 300 receives the fluid flow information, the data analyzer 300 may totalize the fluid flow to obtain a leak rate substantially instantaneously. The data analyzer 300 totalizes the fluid flow through the flow meters 210A, 2106 by incrementally summing the mass flow by integrating rate over time. The data analyzer 300 outputs the information to an external display 400, such as a computer screen or other electronic display, as the pressure test occurs, and a user is able to determine whether the tubular sections 120A, 1206 are leaking substantially instantaneously. Furthermore, because the data analyzer 300 is able to totalize the mass flow rate over time, the leak rate of the tubular sections 120A, 120B may be quantified. More specifically, the leak rate of the tubular sections 120A, 120B may be quantified as a mass flow leak rate over a specific period of time.

As mentioned previously, both the test equipment assembly 100 and the leak detection assembly 200 may be calibrated prior to the start of a pressure test. With respect to the leak detection assembly 200, the leak detection assembly 200 may be calibrated by using a leak detection assembly calibrator 600, such as a metering syringe, to inject a fluid such as an inert gas at a specified pressure into the leak detection assembly 200 and by reading the information generated by the flow meters 210A, 210B. More specifically, and as shown in FIG. 3, fluid may be injected through an optional filter 230A, 230B and through an entry valve 240A, 240B. As shown in FIG. 3, the left portion of the schematic is essentially a first system (“System A”) and the right portion of the schematic is essentially a second system (“System B”.) System A and System B may be virtually identical, and each of System A and System B may be calibrated independently. For purposes of disclosure, the following discussion describes fluid flow through either System A or System B.

After the fluid is injected through the filter 230A, 230B by the leak detection assembly calibrator 600, fluid may enter the entry valve 240A, 240B. The fluid may pass through one or more relays 242A, 242B, which are optional. The fluid may then pass through a pressure transducer 250A, 250B, also optional, which provides a visual indication of the pressure flowing through the System A, B. The fluid may also pass through an optional pressure gauge 260A, 260B, which may provide a pressure reading of the fluid entering into the leak detection assembly 200. The fluid then flows through a calibration check valve 270A, 270B, which is a uni-directional valve that ensures fluid flows toward the flow meter 210A, 210B during calibration, and does not flow back into the pressure transducer 250A, 2508 or pressure gauge 260A, 260B, which would adversely affect the calibration. Following the calibration check valve 270A, 270B, the fluid may flow past a leak detection block valve 280A, 280B, into the flow meter 210A, 210B, and out through the check valve 220A, 220B to atmosphere. During calibration, the conduits 160, 170 are not connected to the flow meter 210A, 210B, and fluid flow may only move through the check valve 220A, 220B. After the leak detection assembly 200 is properly calibrated, the leak detection block valve 280A, 280B may be placed in the closed position, so that when the conduits 160, 170 are connected to the flow meters 210A, 210B, the fluid may only flow through the flow meters 210A, 210B and out through the check valves 220A, 220B. The leak detection assembly 200 may be calibrated to National Institute of Standards and Technology (“NIST”) standards.

In one embodiment, the leak detection assembly calibrator 600 may be a calibrated micro flow device that is capable of injecting fluid at a specified pressure through either System A or System B. The calibrated micro flow device may be an equivalent channel diameter (“ECD”) device, such as one provided by ATC, Inc. of Indianapolis, Ind.

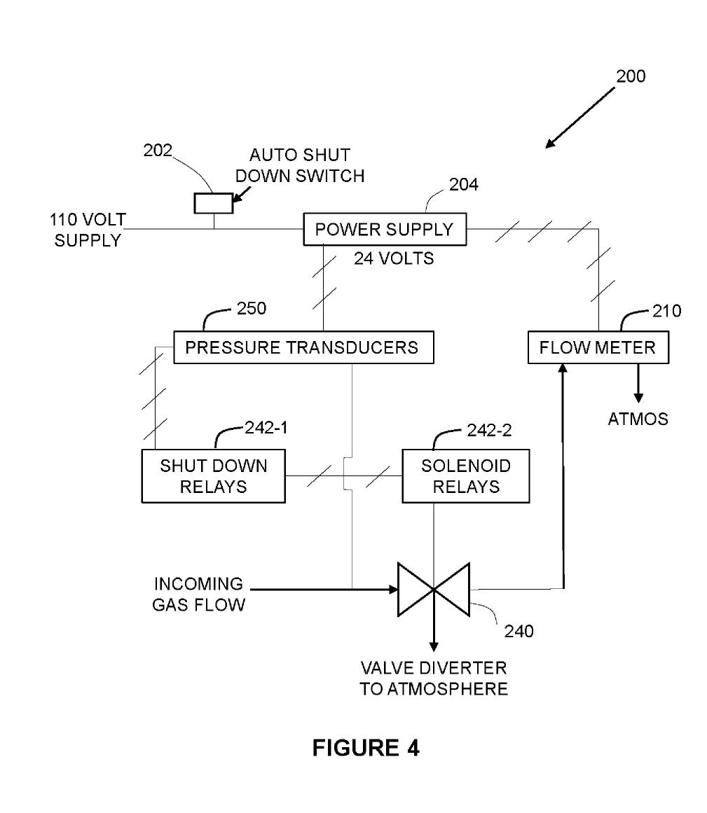

FIG. 4 illustrates a block diagram of the leak detection assembly 200 that may be included in the system of FIG. 1, according to one or more embodiments disclosed. More specifically, FIG. 4 illustrates an overview of the electrical system of the system of FIG. 1, according to one or more embodiments disclosed. In one embodiment, a 110 volt power supply flows through an automatic shutdown switch 202 and into a power supply 204. The power supply 204, in turn, provides 24 volts to the remainder of the leak detection assembly 200. Specifically, 24 volts of electricity may be supplied to the flow meter 210. In addition 24 volts of electricity may be supplied to the pressure transducers 250 and relays 242-1, 242-2. The relays 242-1, 242-2 may include a shutdown relay 242-1, and may include a solenoid relay 242-2, both of which are optional components. Should the shutdown switch 202 receive a power surge from the power supply 204, the shutdown switch 202 may direct one or more of the relays 242-1, 242-2 to shut down the leak detection assembly 200.

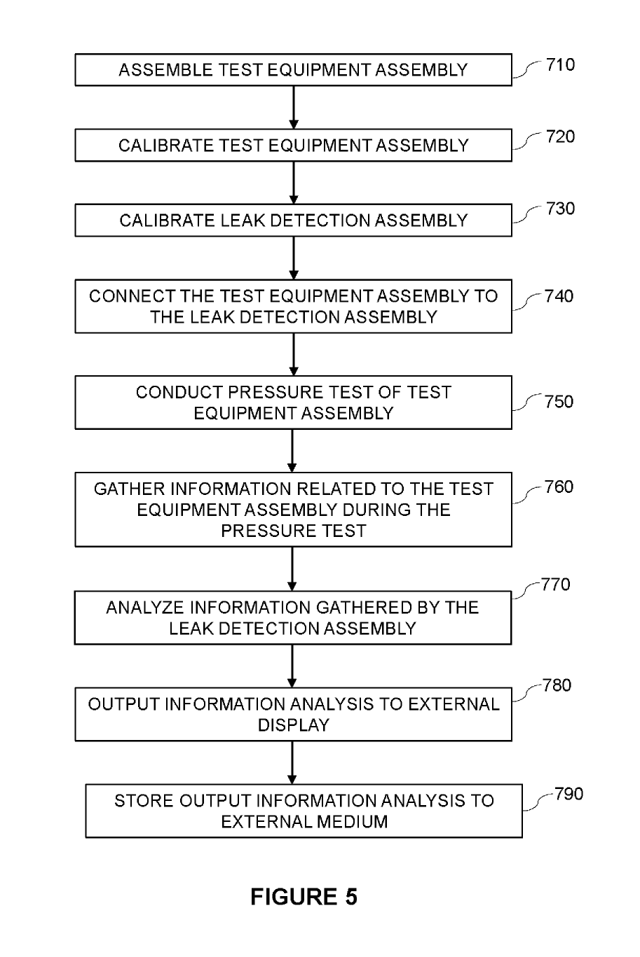

FIG. 5 is a flowchart of an illustrative method 700 for identifying and quantifying a leak within a tubular section 120A, 120B of a test equipment assembly 100, according to one or more embodiments disclosed. The method 700 may include assembling the test equipment assembly 100, as at 710. The method 700 may further include calibrating the test equipment assembly 100 by using a test equipment calibrator 500, as at 720. The method 700 may include calibrating a leak detection assembly 200 by using a leak detection assembly calibrator 600, as at 730. The method 700 may include connecting the test equipment assembly 100 to the leak detection assembly 200, as at 740. The method 700 may further include pressure testing the test equipment assembly 100, as at 750. Pressure testing the test equipment assembly 100 may include holding a tubular section 120A, 120B of the test equipment assembly 100 at a predetermined pressure for a certain period of time. The method 700 may further include calibrating the test equipment assembly 100 by using a test equipment calibrator 500 at the end of pressure test to verify data quality throughout the test, as at 755. The method 700 may include gathering information related to the test equipment assembly 100 during the pressure test, as at 760. The method 700 may further include analyzing the information gathered, as at 770. The analysis of the information may include determining a leak rate of the tubular section 120A, B over the certain period of time. The method 700 may include displaying the analysis of the pressure test on an external display, as at 780. Displaying the analysis of the pressure test on the external display may be substantially instantaneous. The method 700 may also include recording the analysis of the pressure test on an external medium, such as a flash drive, as at 790.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A leak detection system, comprising:
a test equipment assembly including a tubular section, the test equipment assembly configured to pressurize the tubular section during a pressure test;
a leak detection assembly connected to the test equipment assembly, the leak detection assembly configured to detect information related to the tubular section during the pressure test of the tubular section; and
a data analyzer connected to the leak detection assembly and configured to process the information detected by the leak detection assembly, wherein the data analyzer is configured to produce a leak rate of the tubular section.

2. The leak detection system of claim 1, wherein the test equipment assembly includes a plurality of tubular sections.

3. The leak detection system of claim 2, wherein the leak detection assembly includes a flow meter.

4. The leak detection system of claim 3, wherein the flow meter is a Coriolis meter.

5. The leak detection system of claim 2, wherein the leak detection assembly includes a flow meter, and wherein a conduit connects the flow meter to the test equipment assembly.

6. The leak detection system of claim 1, further comprising an external display configured to display the leak rate of the tubular section.

7. The leak detection system of claim 6, wherein the external display is configured to display the pressure within the tubular section substantially instantaneously.

8. A method of detecting leaks, comprising:
assembling a test equipment assembly;
connecting a leak detection assembly to the test equipment assembly;
connecting the leak detection assembly to a data analyzer;
pressurizing the test equipment assembly;
detecting information related to the test equipment assembly during the pressurization; and
displaying an analysis of the information on an external display.

9. The method of claim 8, further including calibrating the test equipment assembly.

10. The method of claim 9, further including calibrating the leak detection assembly.

11. The method of claim 8, further including:
holding a tubular section of the test equipment assembly at a predetermined pressure for a certain period of time; and
determining the leak rate of the tubular section over the certain period of time, wherein the analysis of the information includes the leak rate of the tubular section.

12. The method of claim 11, wherein the analysis of the information is displayed almost instantaneously on the external display during the pressurization.

13. A leak detection system for test equipment, including:
a flow meter configured to detect information transmitted from a test equipment assembly via a conduit during a pressure test of the test equipment; and
a data analyzer connected to the flow meter, wherein the data analyzer is configured to use the information detected by the flow meter to determine a leak rate of the test equipment.

14. The leak detection system of claim 13, further including an external display configured to display the leak rate of the test equipment during the pressure test.

15. The leak detection system of claim 14, wherein the external display is configured to display the pressure within the test equipment substantially instantaneously during the pressure test.

16. The leak detection system of claim 13, further comprising a calibration system configured to calibrate the flow meter.

17. The leak detection system of claim 16, wherein the calibration system further includes a calibration syringe configured to inject a fluid into the flow meter at a calibration pressure.

18. The leak detection system of claim 16, wherein the calibration system further includes an equivalent channel diameter calibrated micro flow device configured to inject a fluid into the flow meter at a calibration pressure.

19. The leak detection system of claim 16, wherein the flow meter is isolated from the calibration system during the pressure test.

20. The leak detection system of claim 16, wherein the flow meter is isolated from the test equipment assembly during calibration of the flow meter.
